(19) United States
(12) Patent Application Publication
(10) Pub. No.: US 2026/0038713 A1
(43) Pub. Date: Feb. 5, 2026

(54) CORROSION RESISTANT WIRELINE CABLE

(71) Applicant: Schlumberger Technology Corporation, Sugar Land, TX (US)

(72) Inventors: Joseph Varkey, Richmond, TX (US); Antonio Mauricio Cevallos Navarrete, Missouri City, TX (US); Sheng Chang, Sugar Land, TX (US); Aman Choudhary, Abbeville (FR); Piljae Joo, Richmond, TX (US); Taysir Salim, Sugar Land, TX (US); Muhammad Usman, Stafford, TX (US); David Geehyun Kim, Katy, TX (US); Tam Tran, Sugar Land, TX (US); Taryn Copeland, Katy, TX (US)

(21) Appl. No.: 19/289,396

(22) Filed: Aug. 4, 2025

Related U.S. Application Data
(60) Provisional application No. 63/679,312, filed on Aug. 5, 2024.

(51) Int. Cl. H01B 7/28; H01B 3/00; H01B 3/30; H01B 7/02; H01B 7/18; H01B 7/22; H01B 7/36; H01B 13/00; H01B 13/14; H01B 13/24

(52) U.S. Cl. CPC H01B 7/2806; H01B 3/004; H01B 3/30; H01B 7/0225; H01B 7/187; H01B 7/226; H01B 7/361; H01B 13/0013; H01B 13/0016; H01B 13/141; H01B 13/144; H01B 13/148; H01B 13/245

(57) ABSTRACT

A method of manufacturing a corrosion-resistant wireline cable includes embedding a first layer of armor wires onto a core cable using a heated carbon fiber reinforced polymer. A second layer of carbon fiber reinforced polymer is then extruded to envelop the first layer of armor wires. In one method, a layer of virgin or colored polymer is extruded over the second layer, and a second layer of armor wires is embedded through the virgin or colored polymer, displacing it to envelop the outer armor wires. In another method, each wire in the second armor layer is coated with virgin polymer before being embedded into the second carbon fiber reinforced polymer layer. The assembly is then heated to cause the virgin polymer to migrate outward, forming an outermost layer. In both methods, a final jacket layer is applied over the exterior to complete the cable. The resulting cable provides corrosion resistance and mechanical reinforcement.

### CROSS-REFERENCE

The present disclosure claims priority from U.S. Provisional Patent Application No. 63/679,312, filed on Aug. 5, 2024, and herein incorporated by reference in their entireties.

### BACKGROUND

Short carbon fiber reinforced polymer is a composite material that has gained preference in the construction of wireline cables due to its superior strength, lightweight nature, corrosion resistance, and exceptional fatigue, cut and abrasion resistance. The low friction characteristic of short carbon fiber reinforced polymer also makes it an ideal choice for constructing the outer cable jacket of wireline cables. To further enhance such wireline cables, metallic armor wires such as galvanized improved plow steel (GIPS) or metal alloys are added to are embedded into the polymer layer to provide the required cable strength.

However, the manufacturing process of such wireline cables using short carbon fiber reinforced polymer presents two significant challenges. The first challenge lies in effectively bonding an outer short carbon fiber reinforced polymer jacket to an inner short carbon fiber reinforced polymer layer. The second challenge arises from the fact that short carbon fiber reinforced polymer absorbs infrared (IR) radiation when heating with IR heater, which causes degradation of the polymer, causing bonding issues to the outer jacket and also contaminates the mirrors of the IR heater, making it inefficient to run through long length of cables.

To harness the above-mentioned strengths of short carbon fiber reinforced polymer in wireline cables effectively, these challenges must be addressed.

### SUMMARY

A corrosion-resistant wireline cable and methods of manufacturing the same are disclosed. In general, the cable includes a core cable surrounded by multiple layers of polymer and armor wire configured to provide mechanical strength, corrosion resistance, and environmental sealing. Two distinct methods for producing the cable are described, each resulting in a similar layered structure but using different material deposition and consolidation techniques.

In a first method, a first layer of carbon fiber reinforced polymer is heated to embed a first layer of armor wires onto the core cable. A second layer of carbon fiber reinforced polymer is then extruded to envelop the first layer of armor wires. A layer of virgin or colored polymer is subsequently extruded to envelop the second polymer layer. A second layer of armor wires is embedded through the virgin polymer layer such that the wires envelop the first layer of armor wires, pushing the virgin polymer to envelop the second armor layer. A final jacket layer with carbon fiber reinforced polymer is then applied over the virgin polymer to complete the cable structure.

In a second method, a first layer of carbon fiber reinforced polymer is again heated to embed a first layer of armor wires onto a core cable, followed by the extrusion of a second carbon fiber reinforced polymer layer to envelop the first armor layer. A second layer of armor wires is then embedded into the second polymer layer, with each armor wire being individually enveloped in a virgin polymer. The cable is then heated to cause the virgin polymer to migrate outward, forming an outermost layer that covers the second armor layer. A final jacket layer with carbon fiber reinforced polymer is applied over this outermost virgin polymer layer to complete the assembly.

Both methods yield a multi-layered wireline cable in which two armor layers are embedded and encapsulated within polymeric materials, with at least one layer of virgin polymer forming between armor wire layer and corrosion-resistant exterior surface. The resulting cable is suitable for use in harsh environments, including downhole oil and gas operations, where resistance to corrosion, mechanical stress, and environmental exposure is required.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 is an illustration of an example flowchart of a method for producing a wireline cable, according to one or more examples of the disclosure.

FIG. 2 illustrates the stages of the flowchart from FIG. 1.

FIG. 3 is an illustration of another example flowchart of a method for producing a wireline cable, according to one or more examples of the disclosure.

FIG. 4 illustrates the stages of the flowchart from FIG. 3.

### DETAILED DESCRIPTION

Illustrative examples of the subject matter claimed below will now be disclosed. In the interest of clarity, not all features of an actual implementation are described in this specification. It will be appreciated that in the development of any such actual implementation, numerous implementation-specific decisions may be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Embodiments of the present disclosure may direct towards wireline cables constructed with short carbon fiber reinforced polymer, and methods for constructing the same.

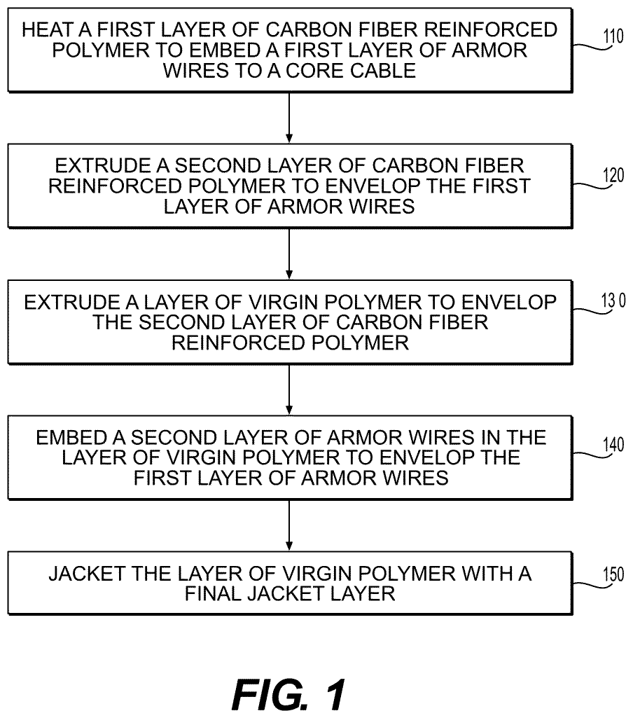

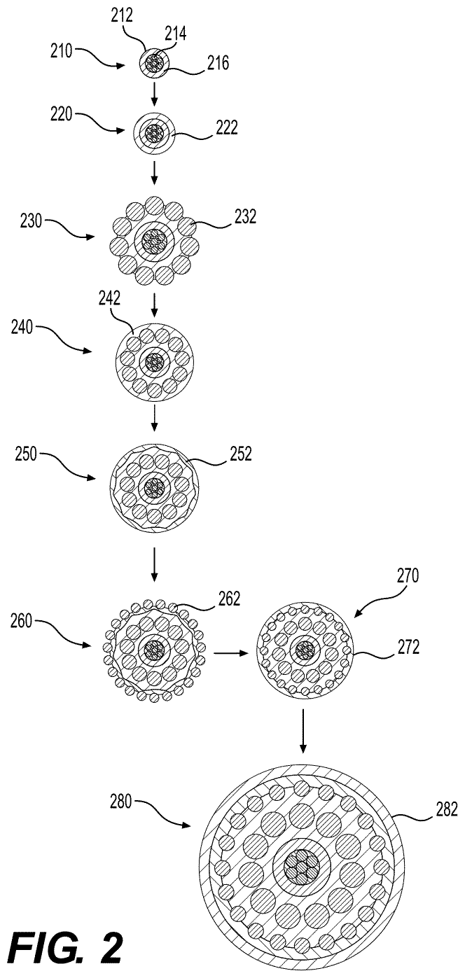

FIG. 1 is an illustration of an example flowchart of a method for producing a wireline cable, according to one or more examples of the disclosure. FIG. 2 illustrates the stages of the flowchart from FIG. 1 and is described concurrently with FIG. 1.

At stage 110 (illustrated at 210 and 220 of FIG. 2), a first layer of carbon fiber reinforced polymer 222 can be heated and applied around a core cable 212 in a manner that causes a first layer of armor wires 232 to become embedded within the polymer 222. The carbon fiber reinforced polymer 222 can comprise a thermoplastic or thermoset base resin loaded with short carbon fibers to improve mechanical strength, rigidity, and resistance to corrosion. The polymer 222 can be pre-compounded with the carbon fibers or the fibers may be introduced at the time of processing. Heating the material softens or melts the polymer matrix, enabling the armor wires to be embedded into the polymer as the core cable and armor wires are drawn through a forming or consolidation device.

The core cable 212 can include one or more conductors, fiber optic elements, or other functional elements (illustrated by 214) housed within a central sheath or tube 216. The first layer of armor wires 232 can be helically wrapped or laid longitudinally along the outer surface of the core cable 212 after application of the heated polymer 222, as illustrated at 230 of FIG. 2. As the heated carbon fiber reinforced polymer 222 is applied, pressure and temperature are maintained to cause the polymer 222 to flow around and between the armor wires 232, creating a bonded interface that holds the armor wires 232 in place relative to the core 212.

This embedding process helps to mechanically secure the armor wires 232 to the core cable 212 and reduces potential for movement or abrasion during use. Additionally, the carbon fiber reinforcement provides a degree of corrosion resistance and stiffness not typically present in unfilled polymers, which may improve the durability and operational life of the wireline cable in downhole environments. The resulting composite structure from stage 110 serves as a foundational layer for subsequent encapsulation and reinforcement steps.

In one or more embodiments, the heating of the first layer of short carbon fiber reinforced polymer 222 can result in a 65%-99% coverage the space between each armor wire in the armor layer. The coverage provided by the first layer of amor wires 232 protects the short carbon fiber 222 and the core cable 212 from heat degradation when the armored cable is run through an infrared (IR) heater.

At stage 120 (illustrated at 240 of FIG. 2), a second layer of carbon fiber 242 reinforced polymer can be extruded over the previously embedded first layer of armor wires 232 to form a continuous enveloping layer. This second layer 242 serves to encapsulate the first armor layer 232 and create a structurally integrated composite section. The extrusion process can include feeding the carbon fiber reinforced polymer 242, which can be a thermoplastic or thermoset material loaded with short carbon fibers, into an extruder where it is melted or otherwise plasticized and then applied concentrically over the underlying structure.

The second layer of carbon fiber reinforced polymer 242 conforms closely to the contours of the armor wires 232 filling any voids between armor wires 232 and forming a consolidated mass. The use of short carbon fibers in this layer continues to provide improved mechanical properties, including increased compressive strength, resistance to deformation, and thermal stability. This layer also contributes to environmental resistance by providing a barrier to ingress of corrosive fluids, gases, or particulate matter commonly encountered in downhole or industrial environments.

During extrusion, process parameters such as temperature, pressure, and line speed can be controlled to ensure adequate bonding between the first and second polymer layers and to minimize the formation of internal stresses or delamination zones. The resulting layered structure—comprising the core cable, embedded first armor layer, and overlying second polymer layer—provides a mechanically reinforced and corrosion-resistant intermediate assembly suitable for receiving additional protective and reinforcing components in subsequent stages of the cable manufacturing process.

In one or more embodiments, the extruding of the second layer of short carbon fiber reinforced polymer 242 fills cusp spaces of the first layer of armor wires 232 while partially or fully encapsulating them.

At stage 130 (illustrated at 250 of FIG. 2), a layer of virgin (or colored) polymer 252 can be extruded over the second layer of carbon fiber reinforced polymer 242 to form an intermediate sheath. The virgin polymer 252 can be a non-reinforced thermoplastic selected for its processability, adhesion characteristics, or compatibility with subsequent manufacturing steps. Examples can include polyethylene, polypropylene, or other polyolefins, although other polymer materials may also be used depending on the target application and environmental requirements.

The extrusion of the virgin polymer layer 252 serves several functions. First, it provides a smooth outer surface to support uniform placement and embedding of the second layer of armor wires 262 in the next stage. Second, it forms a compliant buffer layer between the rigid carbon fiber-reinforced base and the outer armor, allowing the armor wires to be seated and partially embedded without damaging the underlying structure. Third, this layer may act as a visual indicator or marking layer if a colored polymer is used, which can assist in manufacturing quality control or field identification.

Process parameters such as temperature and pressure can be selected to ensure the virgin polymer layer 252 bonds sufficiently to the underlying carbon fiber reinforced polymer without degrading the mechanical integrity of either material. The extrusion die geometry may be configured to control the thickness and concentricity of the virgin polymer layer 252. The resulting structure at this stage is a multi-layered cable subassembly that incorporates a reinforced core and a smooth, outer polymer sheath in preparation for additional reinforcement with a second armor layer.

In one or more embodiments, the carbon fiber reinforced polymer 222 and 242 can be Tefzel, perfluoroalkoxy alkane (PFA), fluorinated ethylene propylene (FEP), expanded polycarbonate (EPC), polyetheretherketone (PEEK), polyketone, thermoplastic polyester elastomer, thermoplastic polyimide or any other suitable polymers having a concentration of 0.01% to 30% short carbon fiber.

At stage 140 (illustrated at 260 of FIG. 2), a second layer of armor wires 262 can be embedded into the layer of virgin polymer 252 applied in the previous stage. This can be accomplished by helically wrapping or pressing the second armor wires 262 onto the surface of the virgin polymer layer 252 while the polymer is still in a thermoplastic or semi-molten state. As the armor wires 262 are applied under pressure, they displace the outer surface of the virgin 252 polymer and become partially embedded within it. This embedding action causes the virgin polymer 252 to flow around and between the second layer of armor wires 262, enveloping them and forming a mechanically interlocked structure, as illustrated at 270 of FIG. 2.

The second layer of armor wires 262 can be constructed from corrosion-resistant metallic materials such as stainless steel, or from alternative high-strength materials depending on the intended environment. The winding pattern, pitch, and angle of application can be selected based on desired mechanical properties such as tensile strength, torque balance, and flexibility. This second armor layer 262 can overlay the first armor layer 232 and further reinforce the cable 212 against crushing, impact, or tensile loading during deployment and retrieval operations.

As the wires are embedded into the virgin polymer 252, care can be taken to maintain alignment and consistent tension to avoid kinking or distortion. The embedding process not only secures the armor wires 262 in place but also ensures a consistent cable geometry suitable for the final jacketing step. The interaction between the virgin polymer 252 and the armor wires 262 at this stage also contributes to environmental sealing, limiting the ingress of water, chemicals, or gas into the cable's inner layers. The resulting structure integrates both armor layers 232, 262 within a polymer matrix, forming a ruggedized and corrosion-resistant assembly.

In one or more embodiments, the embedding of the second layer of armor wires 262 to the layer of colored or virgin polymer 252 may result in a 40%-98% coverage of the second layer of armor wires 262. In one or more embodiments, the armoring of the layer of colored or virgin polymer 252 is achieved by running through an IR heater. In one or more embodiments, the embedding of the second layer of armor wires 262 to the layer of colored or virgin polymer 252 pushes the second layer of armor wires 262 to envelop the first layer of armor wires 232, with the colored or virgin polymer 252 covering the second layer of armor wires 262.

At stage 150 (illustrated at 280 of FIG. 2), the outer surface of the cable—comprising the virgin polymer layer 252 with the embedded second layer of armor wires 262—can be encapsulated with a final jacket layer 282. This jacket 282 can be applied through an extrusion or overjacketing process using a durable polymer material selected for environmental resistance, abrasion resistance, or compatibility with specific operational environments. Suitable jacket materials can include carbon fiber reinforced high-density polyethylene (HDPE), polyurethane, fluoropolymers, or other polymers that provide enhanced protection against physical and chemical degradation.

The final jacket layer 282 serves as the cable's outermost barrier, shielding the underlying layers from mechanical wear, chemical exposure, and environmental contaminants. During extrusion, the jacket material can be applied in a molten state and conformed to the shape of the underlying cable structure, filling in any surface gaps and bonding with the outer portions of the virgin polymer laver. The thickness of the jacket 282 can be adjusted depending on the desired level of protection and flexibility. In some embodiments, a colored jacket material can be used to indicate the cable type, manufacturer, or specific design parameters.

Proper application of the jacket layer 282 can be important to ensure continuous coverage and uniform wall thickness. The extrusion parameters—such as melt temperature, line speed, and cooling rate—can be controlled to avoid voids, delamination, or thermal degradation of the underlying layers. Once cooled, the final jacket layer 282 completes the multi-layered wireline cable assembly, resulting in a corrosion-resistant and mechanically reinforced structure suitable for use in harsh environments such as downhole oil and gas operations or other industrial applications requiring robust, long-life cable performance.

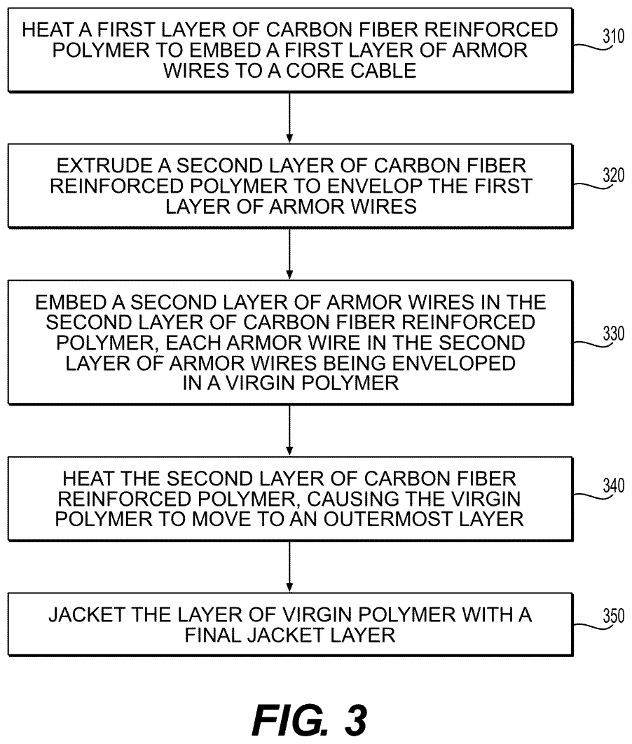

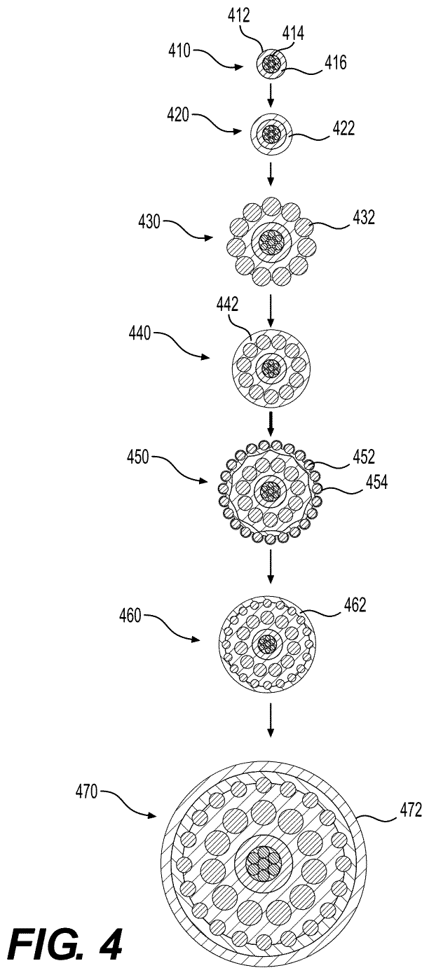

FIG. 3 is an illustration of an example flowchart of another method for producing a wireline cable, according to one or more examples of the disclosure. FIG. 4 illustrates the stages of the flowchart from FIG. 3 and is described concurrently with FIG. 3.

At stage 310 (illustrated at 410, 420, and 430 of FIG. 4), a first layer of carbon fiber reinforced polymer 422 is heated and used to embed a first layer of armor wires 430 to a core cable 412. The core cable 412 can include one or more signal conductors 414, fiber optics, or power transmission elements, enclosed in a sheath or insulation layer 416. The carbon fiber reinforced polymer 422 can consist of a thermoplastic or thermoset resin matrix with dispersed short carbon fibers, selected to enhance structural strength, stiffness, and corrosion resistance. Heating the polymer 422 softens it sufficiently to enable flow and consolidation around the armor wires 432 and the outer surface of the core cable 412.

The first layer of armor wires 432 can be pre-positioned along the core cable 412, such helically wound or longitudinally aligned, and brought into contact with the core 412 after the application of the heated polymer 422. The heat and pressure during this step result in embedding the armor wires 432 into the carbon fiber reinforced polymer 422, forming a bonded structure that mechanically secures the armor wires 432 in place.

This embedded configuration provides the cable with a reinforced inner structure capable of withstanding mechanical loads while protecting the core elements from damage during handling and operation. The use of carbon fiber reinforcement within the polymer helps limit material creep, deformation, and corrosion under high-temperature or chemically aggressive conditions. The resulting intermediate assembly, composed of the core cable and embedded first layer of armor wires, forms a structural base for the application of additional layers in subsequent stages.

At stage 320 (illustrated at 440 of FIG. 4), a second layer of carbon fiber reinforced polymer 442 is extruded to envelop the first layer of armor wires 432 that was embedded during stage 310. The extrusion process can include feeding a polymer compound—reinforced with short carbon fibers—into an extruder where it is melted and continuously applied over the underlying cable structure. This second polymer layer 442 fully surrounds the first layer of armor wires 432, forming a consolidated and protective outer shell that mechanically integrates with the earlier-applied material.

The extruded second layer serves multiple functions. Structurally, it adds an additional degree of mechanical strength and rigidity to the cable, further reinforcing the embedded armor wires and minimizing the risk of mechanical displacement, deformation, or fatigue. Environmentally, this layer serves as a barrier against moisture, chemicals, and other corrosive agents, protecting both the inner armor wires and the core cable. The inclusion of carbon fiber reinforcement continues to enhance the material's dimensional stability and resistance to cracking or delamination under thermal and mechanical cycling.

Care can be taken to ensure uniform coverage and consistent bonding between the first and second layers of polymer. This can involve controlling extrusion parameters such as melt temperature, pressure, and die design. Proper consolidation between layers is important to form a structurally coherent composite rather than discrete or weakly bonded layers. The resulting structure—core cable, embedded first armor layer, and enveloping second carbon fiber reinforced polymer layer—provides a robust base for integrating the second armor layer and virgin polymer in subsequent processing steps.

At stage 330 (illustrated at 450 FIG. 4), a second layer of armor wires 452 is embedded into the second layer of carbon fiber reinforced polymer 442 applied during stage 320. Each armor wire in the second layer 452 is separately enveloped in a virgin (or colored) polymer 454 before or during its application to the cable. The virgin polymer 454 can be a thermoplastic material selected for its flexibility, chemical resistance, or ability to flow when heated. Suitable materials may include polyethylene, nylon, or similar polymers that can provide localized encapsulation around each wire.

The second layer of armor wires 452 can be helically wrapped or otherwise arranged around the cable in a uniform pattern. As each armor wire is applied, it either carries a pre-applied coating of virgin polymer 454 or passes through an applicator or extrusion die that deposits the virgin polymer 454 around it in real time. Once applied, the virgin polymer 454 surrounds each individual wire and comes into contact with the surface of the second layer of carbon fiber reinforced polymer 442. At this stage, the polymer layers remain in a thermoplastic or semi-solid state, allowing for partial interfacial bonding between the virgin polymer and the surrounding matrix.

The embedding of the virgin-polymer-coated armor wires within the second carbon fiber reinforced polymer 442 layer creates a multi-material structure in which the second armor layer is both mechanically supported by and chemically isolated from the underlying cable body. This configuration allows for enhanced protection of the second armor wires against corrosion, particularly in cases where the armor wires are exposed to chemically aggressive downhole environments. The virgin polymer 454 acts as a corrosion-resistant buffer while maintaining the structural integration of the armor wires within the composite cable architecture.

At stage 340 (illustrated at 460 of FIG. 4), the second layer of carbon fiber reinforced polymer 442 is heated to cause the virgin polymer 454—previously enveloping each armor wire in the second layer—to migrate outward and form an outermost layer 462 on the cable. This is accomplished by selectively heating the composite structure to a temperature at which the virgin polymer 452 becomes sufficiently fluid to flow, while the carbon fiber reinforced polymer 442 remains dimensionally stable. The difference in flow characteristics between the two materials enables the virgin polymer 452 to redistribute from around individual armor wires 452 to the exterior surface of the cable assembly.

As the virgin polymer 454 flows, it moves through gaps and interstices between adjacent armor wires 452 and spreads across the surface of the cable. This results in a continuous outer coating 462 of virgin polymer that covers the second layer of armor wires 452 and serves as an environmental barrier. The heating process can be performed using controlled convection, infrared, or induction heating systems, depending on the thermal properties of the materials and the desired migration behavior. The process is managed to ensure uniform coverage and to prevent overheating that could degrade either the virgin polymer or the underlying composite layers.

This stage produces a self-forming protective sheath without the need for a separate extrusion pass. The outermost layer of virgin polymer 462 provides a smooth surface and shields the armor wires from mechanical wear and corrosive exposure. The result is a cable structure in which the second layer of armor wires 452 remains mechanically integrated within the cable body while being externally encapsulated in a polymer that can be optimized for chemical resistance, flexibility, or other performance characteristics.

At stage 350 (illustrated at 470 of FIG. 4), the outermost layer of virgin polymer 462—formed during the heating and migration process of stage 340—is encapsulated with a final jacket layer 472. This jacket 472 can be applied through an extrusion or overjacketing process using a durable polymer material that serves as the cable's primary external barrier. The jacket material can be selected based on environmental and operational requirements and can include polymers such as carbon fiber reinforced polyethylene, polyurethane, polyamide, or other abrasion- and chemical-resistant materials.

The jacketing process can include extruding the final jacket material over the cable while the cable is passed through a die. During this process, the outer surface of the virgin polymer layer 462 is contacted by the molten jacket material, which conforms to the cable profile and bonds to the surface upon cooling. The jacket thickness is controlled to achieve the desired balance between mechanical protection, flexibility, and overall cable diameter. The extrusion parameters—such as temperature, pressure, and line speed—are adjusted to maintain adhesion without compromising the underlying layers.

The final jacket 472 can serve several functions: it protects the cable from mechanical damage during handling, deployment, and retrieval; it prevents the ingress of water, chemicals, and gases into the internal layers; and it provides an interface compatible with sealing systems or connectors used in downhole or industrial environments. In some cases, a colored jacket material may be used for identification or traceability. The resulting product is a corrosion-resistant, mechanically robust, and environmentally sealed wireline cable suitable for long-term use in demanding conditions.

In one or more embodiments, the methods described herein can further comprise jacketing the second layer of short carbon fiber reinforced polymer with a polymer jacket.

Advantageously, with the colored or virgin polymer covering the second layer of armor wires, it allows heating of the colored or virgin polymer using an IR heater for the final jacketing to allow the virgin or colored polymer layer to bond to the outer jacket. Other than that, the cusp spaces above, below, and adjacent of the second layer of armor wires are partially or fully filled. Furthermore, it allows both layers of armor wires to be surrounded partially or fully by carbon fiber reinforced polymer to protect the armor wire layers from acidic and hydrogen rich environment.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the claims and their equivalents below.

What is claimed is:

1. A method for producing a wireline cable, comprising:
heating a first layer of short carbon fiber reinforced polymer to embed a first layer of armor wires enveloping a core cable;
extruding a second layer of short carbon fiber reinforced polymer to envelop the first layer of short carbon fiber reinforced polymer;
extruding a layer of colored or virgin polymer to envelop the second layer of short carbon fiber reinforced polymer; and
embedding a second layer of armor wires to through the layer of colored or virgin polymer to envelop the first layer of armor wires, which pushes the layer of colored or virgin polymer to envelop the second layer of armor wires.

2. The method of claim 1, further comprising jacketing the layer of colored or virgin polymer with a final jacket layer.

3. The method of claim 1, wherein each armor wire forming the second layer of the armor wires is individually extruded with a colored or virgin polymer.

4. The method of claim 2, wherein the heating of the second layer of short carbon fiber reinforced polymer pushes the colored or virgin polyester individually extruded on each armor wire to envelop the second layer of short carbon fiber reinforced polymer.

5. The method of claim 1, wherein the second layer of armor wires is embedded into the layer of colored or virgin polymer while the colored or virgin polymer is in a molten or semi-molten state.

6. The method of claim 1, wherein the colored or virgin polymer comprises a thermoplastic selected from the group consisting of polyethylene, polypropylene, and a fluoropolymer.

7. The method of claim 1, wherein the core cable includes at least one electrical conductor.

8. The method of claim 1, wherein the step of embedding the second layer of armor wires comprises applying the armor wires under tension to ensure partial penetration into the layer of colored or virgin polymer.

9. The method of claim 1, wherein the colored or virgin polymer is applied in a distinct color to enable visual identification of the cable structure during inspection or installation.

10. The method of claim 1, wherein the second layer of short carbon fiber reinforced polymer is extruded using a crosshead die to achieve concentric coverage around the underlying structure.

11. A method for producing a wireline cable, comprising:
heating a first layer of carbon fiber reinforced polymer to embed a first layer of armor wires onto a core cable;
extruding a second layer of carbon fiber reinforced polymer to envelop the first layer of armor wires;
embedding a second layer of armor wires into the second layer of carbon fiber reinforced polymer, wherein each armor wire in the second layer of armor wires is enveloped in a virgin polymer;
heating the second layer of carbon fiber reinforced polymer to cause the virgin polymer to migrate outward and form an outermost layer over the second layer of armor wires; and
jacketing the outermost layer of virgin polymer with a final jacket layer.

12. The method of claim 11, wherein the virgin polymer comprises a thermoplastic selected from the group consisting of polyethylene, polypropylene, and nylon.

13. The method of claim 11, wherein the virgin polymer is applied to each armor wire in the second layer by extrusion prior to embedding the armor wires into the second layer of carbon fiber reinforced polymer.

14. The method of claim 11, wherein heating the second layer of carbon fiber reinforced polymer to cause migration of the virgin polymer comprises applying heat sufficient to soften the virgin polymer while maintaining dimensional stability of the carbon fiber reinforced polymer.

15. The method of claim 11, wherein the final jacket layer comprises a polymer selected from the group consisting of polyurethane, high-density polyethylene (HDPE), and a carbon fiber reinforced polyurethane.

16. The method of claim 1, wherein the first layer of armor wires is helically wound around the core cable prior to embedding in the first layer of carbon fiber reinforced polymer.

17. The method of claim 1, wherein the virgin polymer enveloping each armor wire is applied via an extrusion coating process immediately before embedding the wires into the second carbon fiber reinforced polymer layer.

18. The method of claim 1, wherein heating the second layer of carbon fiber reinforced polymer to cause migration of the virgin polymer comprises heating the cable to a temperature between 150° C. and 250° C.

19. The method of claim 1, wherein the final jacket layer is applied by extrusion over the outermost layer of virgin polymer in a continuous process.

20. The method of claim 1, wherein the second layer of armor wires comprises stainless steel wires to provide enhanced corrosion resistance.
